(19) United States
(12) Patent Application Publication
(10) Pub. No.: US 2011/0241342 A1
(43) Pub. Date: Oct. 6, 2011

(54) Pipe Repair Clamp with Self Pressurizing Seal

(76) Inventors: Michael J. Skellern, Irvine, CA (US); Keith Wyness, Neston (GB); Richard Ollerhead, Thorton Hough (GB)

(21) Appl. No.: 12/752,157

(22) Filed: Apr. 1, 2010

(51) Int. Cl. F16L 25/06; F16J 15/02

(52) U.S. Cl. 285/420; 277/605

(57) ABSTRACT

The invention provides a faster, safer, more reliable and cost-effective method to permanently or temporarily repair leaking in-service pipes than welding and other devices and methods currently used to repair leaking pipes. The interlocking pipe clamp and internal circumferential self-pressurizing seal, installed in a recessed seal groove within the clamp housing, embodies a unidirectional fluid orifice leading to an internal pressure responsive chamber whereby trapped fluids inside the chamber expand outwardly under pressure to force the external sealing surface of several pliable, multi-combed and conjoined fingers to form a series of redundant seals against the leaking pipe with increasingly greater force to prevent the escape of fluids from the pipe and to prevent seal dislodgement from the pipe repair clamp. The seal material is composed of resilient synthetic and natural materials which are corrosion and fire resistant and color coded for specific fluid repair applications.

### STATEMENT OF FEDERALLY SPONSORED RESEARCH/DEVELOPMENT

Not Applicable.

### FIELD AND BACKGROUND OF THE INVENTION

This invention relates to the technical field of repairing and sealing of leaking in-service pipes in the oil and gas, petrochemical, construction, maritime fields. Leaks in pipes can occur by several means including defect caused by corrosion, seam cracking, construction faults, ground movement and third-party interference. Corrosion along welded pipe seams and sulfide stress cracks are the most common cause of leaks in pipelines. Welding during pipeline construction inevitably leads to corrosion at the welded seam as welding burns away the factory applied protective coating leaving the welded seam susceptible to corrosive pipe fluids such as sulfides in crude oil which lead to progressive weld seam deterioration and cracking despite time consuming and costly non-destructive testing (NDT) of the welded seam which is completed after each pipe is joined.

When a segment of a pipeline or piping system is found to be defective and leaking one the common repair methods is to shutdown pipeline operations, degas or vent gas within the pipeline and cut out the defective and leaking pipe section. However, the cost is extremely high in terms of venting and stopping the oil or gas supply in the petroleum industry, or water, steam, or other fluids in pipe systems in the petrochemical, construction and maritime vessels underway. Most pipeline companies have developed in-service repair methods without removing the line from service and these repair methods are used widely throughout the natural gas, petroleum, petrochemical, construction and maritime industries.

### TECHNICAL PROBLEM

Repair of leaking in-service pipes varies in terms of complexity, safety, costs and reliability which are dependent upon the devices and methods used to repair the leak, accordingly to pipe diameter and thickness, fluid contents, line pressure, and environmental conditions, and whether the pipe system must be shutdown and degassed.

Welding into or onto oil or gas pipeline in active operation, called in-service welding, is a technique that is currently employed in the in-service repair of oil and gas pipelines. These devices and methods include sleeve welding, epoxy sleeves, composite material rapping (clock-spring) and direct deposit welding method to repair welded pipe seams and damaged pipe with same shape.

Welding on in-service pipelines presents a series of safety and reliability concerns, including the possibility of burn-through due to the localized heating of the pipe material and loss of material strength on the inner surface of pipe during the welding process, wherein the pipe wall can burst under internal pressure. The second concern is the high cooling rates of the weld by the flowing gas which quickly removes heat from the pipe wall, resulting in accelerated cooling of the weld. The high cooling rate can promote the formation of the heat-affected zone microstructure with high hardness, making these welds susceptible to cold cracking and sulfide stress cracking in sour service. The rapid cooling can be compensated by increasing heat input, but the increased heat input can promote weld penetration and the possibility of burn-through. Thus suitable weld procedures must ensure the optimal heat-affected zone hardness without cracking and no burn-through with proper heat input to avoid reliability and safety failures.

The direct depositions of weld metal, sleeve-repair welding and hot-tap welding are typical examples of in-service welding in the oil and gas industry, which leads to welded seam corrosion and eventual leakage. The epoxy sleeve repair and composite rapping are repair methods of in-service natural gas pipelines and maritime industries. The epoxy sleeve repair need a longitudinal welding of sleeve, but this welding is not performed on live pipelines. The composite repair does not need any welding procedure but has limitations according to fluid contents, inline pressure and preparation.

### SOLUTION TO PROBLEM

The Pipe Repair Clamp with Self-pressurizing Seal invention obviates the inherent limitations of current pipe repair devices and methods used in the oil and gas, petrochemical, construction and maritime industries by providing an improved device and method to replace welding, epoxy sleeves, composite material rapping (clock-spring), clamps and external compression devices, and direct deposit welding and other methods currently used to repair pipes.

### ADVANTAGES

The Pipe Repair Clamp with Self-pressurizing seal provides temporary or permanent in-service pipe repairs for all pipe diameters, fluid contents, line pressures, and applications without costly system shut-down, specialist equipment and labor, providing faster, safer and more reliable pipe repair at substantially lower costs.

### SUMMARY OF THE INVENTION

This pipe repair clamp with self-pressurizing seal obviates the inherent disadvantages of welding and other devices and methods currently used to repair pipes by providing a faster, safer, more reliable and cost-effective method to permanently or temporarily repair leaking in-service pipes of all sizes and fluid contents than welding and other previous devices and methods.

### BRIEF DESCRIPTION OF THE DRAWINGS

The invention is described in further detail with reference to the drawings which represent the embodiments of the invention. Structural details are illustrated only for fundamental understanding of the invention.

Described in the drawings:

FIG. 1 Vertical circumferential view of the pipe repair clamp illustrating the interlocking sections and integral bolt housings according to the invention.

FIG. 2 Vertical three-quarter view of the assembled pipe clamp with seal installed in recessed seal groove.

FIG. 3 Vertical side view of the pipe repair clamp secured around the axial surface of a pipe and showing two of three outwardly angle fastener housings.

FIG. 4 Vertical enlarged cross-sectional view of the pipe repair clamp body and cross section view of the internal self-pressurizing seal installed in the recessed seal groove.

### DETAILED DESCRIPTION OF THE INVENTION

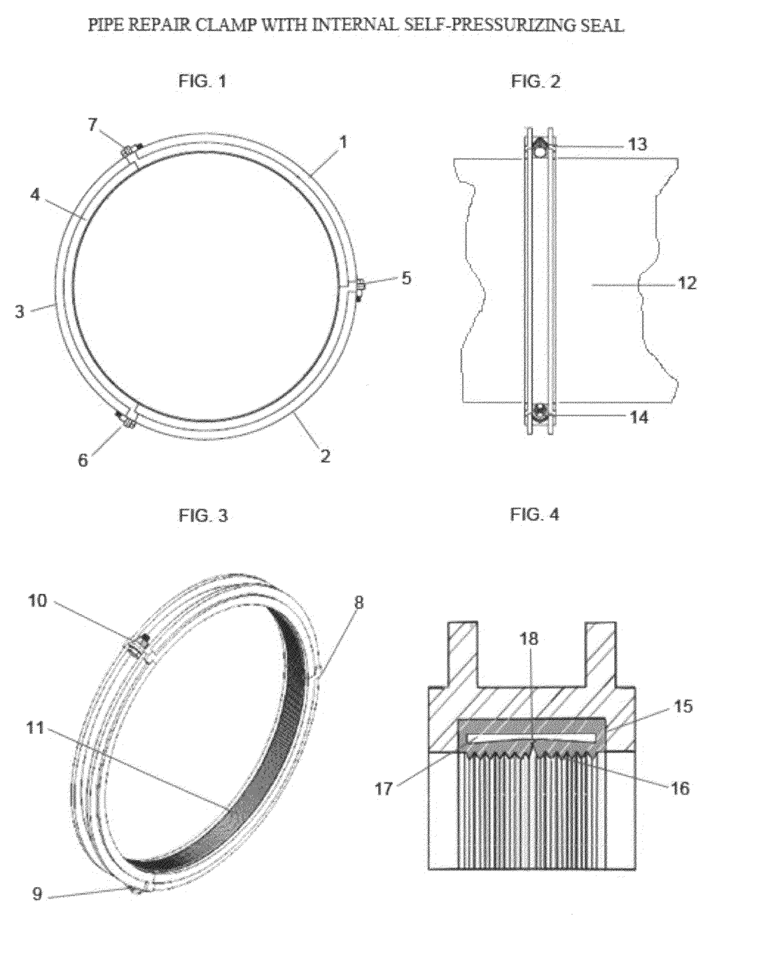

In FIG. 1 there is seen a pipe clamp with a self-sealing device that stops the fluids from pipe leaks in a broad range of sizes, applications, and pressure ranges. The pipe clamp body is comprised of multiple, equal length, inter-locking sections 1, 2, 3 in which an internal recessed seal groove 4 is located, and in which the self-pressurizing multi-combed circumferential lip seal is secured.

In FIG. 2 the self-pressurizing seal 11 is installed in the recessed seal groove 4 and each interlocking section 8, 9, 10 is assembled around the axial surface of a leaking pipe. Each interlocking pipe clamp section consists of integral fastener housings 8, 9, 10 for securing the pipe repair clamp and seal securely around the axial surface of a pipe.

In FIG. 3 there is seen a side view of the pipe repair clamp fastened around a pipe 12 with two of the three pipe clamp fastener housings located at an outward 25° angle 13, 14 to facilitate easy tool access necessary to secure each interlocking pipe clamp section using bolt fasteners. Each interlocking pipe clamp section is uniformly tightened using bolts to secure the pliable multi-combed seal 11 in the recessed seal groove and to compress the pliable, multi-combed lips 11 of the circumferential seal against the outside axial pipe surface to stop the outward flow fluids from the pipe.

In FIG. 4 there is seen a partial cross section of a pipe repair clamp and recessed seal groove 15 with the pliable, multiple-combed and conjoined ridges that form a series of redundant seals is 16 installed in the clamp. The internal pressure responsive chamber 17 traps leaking fluids in internal chamber through a unidirectional inlet orifice 18 located in the center of the multi-combed lips of the self-pressurizing seal. Leaking fluid from a pipe enters the pressure responsive chamber 17 through the unidirectional inlet orifice 18 and is trapped inside the pressure responsive chamber. As pressure increases the pressure responsive chamber 17 the outward pressure force the walls of pressure chamber 17 to expand in an outward direction which place increasing force of the pipe clamp seal's multi-combed lips surface against the pipe surface with greater force and seal efficiency. The outward expansion of the internal pressure responsive chamber 17 simultaneously expands the seal body within the recessed seal groove 15 with greater force as pressure increases to prevent dislodgement of the seal from the clamp.

The self-pressurizing pliable, multiple-combed and conjoined lip seal 15 is manufactured using resilient material manufactured of natural and synthetic composites that are specifically formulated to resist seal degradation by various fluids or corrosive agents and contain a fire retardant to prevent seal failure in case extreme temperatures con. Seals are color-coded according to specific fluid composition.

It is to be understood that the present invention is not limited to the embodiments described above, but encompasses any and all embodiments within the scope of the following claims.

### INDUSTRIAL APPLICABILITY

This pipe repair clamp with self-pressurizing seals has industrial applications in several industries which require temporary or permanent in-service repair of leaking pipes of sizes, fluids contents, and line pressures in the oil and gas, petrochemical, plumbing, and maritime industry, providing faster, safer and more reliability against leaks.

We claim:

1. An interlocking pipe and self-sealing pipe repair clamp consisting of a steel or aluminum body embodying multiple interlocking equal length sections, an internal recessed seal groove to facilitate a self-pressurizing seal, and an integral fastening system with bolt housings angled outwardly 25° for easy fastener access and uniform tightening to secure the pipe repair clamp around any pipe size and to uniformly compress the self-pressurizing seal against the leaking pipe surface to prevent the outward flow of fluids from the leaking pipe.

2. A pliable self-pressurizing multi-combed circumferential seal embodying resilient corrosion resistant synthetic and natural materials, a unidirectional fluid orifice leading to an internal pressure responsive chamber which expands the sealing surface of pliable, multiple and conjoined ridges which form a series of redundant seals to prevent the outward flow of fluids from a pipe.
